(19) United States
(12) Patent Application Publication
(10) Pub. No.: US 2016/0110550 A1
(43) Pub. Date: Apr. 21, 2016

(54) INFORMATION PROCESSING SYSTEM, INFORMATION PROCESSING DEVICE, AND SETTING DETERMINATION METHOD

(71) Applicant: Hiroshi KAKII, Tokyo (JP)

(72) Inventor: Hiroshi KAKII, Tokyo (JP)

(21) Appl. No.: 14/878,172

(22) Filed: Oct. 8, 2015

(30) Foreign Application Priority Data
Oct. 16, 2014 (JP) 2014-211491

(51) Int. Cl. G06F 21/57; G06F 21/56

(52) U.S. Cl. CPC G06F 21/577; G06F 21/56

(57) ABSTRACT

An information processing system determines security setting of an information processing device. The information processing system includes: an evaluating unit that evaluates an incident occurring in an environment that includes the information processing device; a determining unit that determines a setting level, of a plurality of levels, for the security setting corresponding to the incident of the information processing device based on an evaluation result of the incident by the evaluating unit; and a changing unit that changes the security setting corresponding to the incident of the information processing device to security setting corresponding to the setting level determined by the determining unit.

### CROSS-REFERENCE TO RELATED APPLICATIONS

The present application claims priority to and incorporates by reference the entire contents of Japanese Patent Application No. 2014-211491 filed in Japan on Oct. 16, 2014.

### BACKGROUND OF THE INVENTION

1. Field of the Invention

The present invention relates to an information processing system, an information processing device, and a setting determination method.

2. Description of the Related Art

In a commonly used information processing device such as a multifunction peripheral, one of tasks is to achieve a balance between security and convenience. In general, convenience decreases when security strength is increased and, conversely, the security strength decreases when the convenience is increased. For example, a technology for performing lock-out in response to a login failure is known. If the number of consecutive failures as a threshold of the lock-out is reduced or if a lock-out time is increased, the convenience lowers. On the other hand, if the number of consecutive failures as the threshold is increased or if the lock-out time is shortened, this leads to an increase in an opportunity to be attacked.

However, development of the technology is still desired, the technology in which an optimal level of security setting of an information processing device is determined according to an incident actually detected in an environment where the information processing device is used and a balance between security and convenience is eventually achieved.

### SUMMARY OF THE INVENTION

It is an object of the present invention to at least partially solve the problems in the conventional technology.

An information processing system determines security setting of an information processing device. The information processing system includes: an evaluating unit that evaluates an incident occurring in an environment that includes the information processing device; a determining unit that determines a setting level, of a plurality of levels, for the security setting corresponding to the incident of the information processing device based on an evaluation result of the incident by the evaluating unit; and a changing unit that changes the security setting corresponding to the incident of the information processing device to security setting corresponding to the setting level determined by the determining unit.

An information processing device determines own security setting. The information processing device includes: an evaluating unit that evaluates an incident occurring in an environment that includes the information processing device; a determining unit that determines a setting level, of a plurality of levels, for the security setting corresponding to the incident of the information processing device based on an evaluation result of the incident by the evaluating unit; and a changing unit that changes the security setting corresponding to the incident of the information processing device to security setting corresponding to the setting level determined by the determining unit.

A setting determination method determines security setting of an information processing device. The setting determination method includes: evaluating an incident occurring in an environment that includes the information processing device; determining a setting level, of a plurality of levels, for the security setting corresponding to the incident of the information processing device based on an evaluation result of the incident evaluated at the evaluating; and changing the security setting corresponding to the incident of the information processing device to security setting corresponding to the setting level determined at the determining.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of a configuration of a multifunction peripheral according to a first embodiment;

FIG. 2 is a sequence diagram of security setting determination processing performed by the multifunction peripheral according to the first embodiment;

FIG. 3 is a functional block diagram of a detailed configuration of a security level determining unit in the multifunction peripheral according to the first embodiment;

FIG. 4 is a diagram of an example of a data structure of a security counter referred to by the security level determining unit in the multifunction peripheral according to the first embodiment;

FIG. 5A and FIG. 5B are diagrams of an example of a data structure of a determination table referred to by the security level determining unit in the multifunction peripheral according to the first embodiment;

FIG. 6A and FIG. 6B are diagrams of another example of the data structure of the determination table referred to by the security level determining unit in the multifunction peripheral according to the first embodiment;

FIG. 7A and FIG. 7B are diagrams of still another example of the data structure of the determination table referred to by the security level determining unit in the multifunction peripheral according to the first embodiment;

FIG. 8 is a flowchart of processing performed by a schedule management unit in the multifunction peripheral according to the first embodiment;

FIG. 9 is a flowchart of processing performed by the security level determining unit in the multifunction peripheral according to the first embodiment;

FIG. 10 is a functional block diagram of a configuration of a multifunction peripheral according to a second embodiment;

FIG. 11 is a functional block diagram of a configuration of a multifunction peripheral according to a third embodiment;

FIG. 12 is a diagram of a hardware configuration of a security analysis device according to the second and the third embodiments; and

FIG. 13 is a diagram of a hardware configuration of the multifunction peripheral according to the first to the third embodiments.

### DETAILED DESCRIPTION OF THE PREFERRED EMBODIMENTS

Exemplary embodiments of the present invention will be explained below; however, the embodiments are not limited by the embodiments described herein below.

In a first embodiment described below, a multifunction peripheral is used as an example of an information processing system and an information processing device.

The multifunction peripheral according to the first embodiment can provide image processing services such as copying, scanning, and facsimile in response to an instruction from an operator through an operating unit, and can also provide image processing services such as printing, scanning, and facsimile in response to a request from a user through a network. An incident being a threat to security (hereinafter, “security incident”) related to information management and system operation may occur in the multifunction peripheral during providing the services. For example, password cracking using a dictionary attack or a brute force attack is exemplified, and in addition to the above, a case of “forgetting to log out” by the operator is also included.

The multifunction peripheral may provide various security functions in order to deal with occurrence of the security incidents. For example, a lock-out function is provided against the password cracking to control so that when a login failure occurs a predetermined number of times consecutively, another login is not accepted for a give time period. An auto logout function to automatically log out after elapse of a given period of time since the last operation even without being manually logged out after the login is also provided in order to deal with the case of “forgetting to log out”.

Such security functions generally have a tendency that the convenience decreases when the security strength is increased and, conversely, the security strength decreases when the convenience is increased. The lock-out function will be explained as an example. When the number of consecutive failures as a threshold is set to a small number or when the lock-out time is set to a large number, this setting also affects authorized users, and the convenience therefore decreases. On the other hand, when the number of consecutive failures is set to a large number or when the lock-out time is set to a small number, this setting leads to an increase in the opportunity to be attacked per unit time.

In this way, because there is a trade-off relationship between the security strength and the convenience in the security functions, it is desirable to set the security at an appropriate level according to the situation of any incident occurring in the environment where the multifunction peripheral is used. For example, despite no occurrence of a security threat at all, maintaining the security strength to a high level sacrifices the convenience. On the other hand, it is undesirable on security to maintain the security strength to a low level by giving a priority to the convenience despite occurrence of a specific threat or appearance of its sign.

Therefore, the multifunction peripheral according to the embodiment to be explained adopts a configuration that evaluates a security incident occurring in the environment where its own device is used and that determines an appropriate setting level of its own security setting. In an exemplary embodiment, it is possible to dynamically change its own security setting to the setting level that is determined to be appropriate. By determining an appropriate setting level according to an actual situation in the environment where the own device is used and, preferably, by dynamically changing the setting, an unnecessary degrease of the convenience is prevented while maintaining the security strength adjusted to the environment where the own device is used.

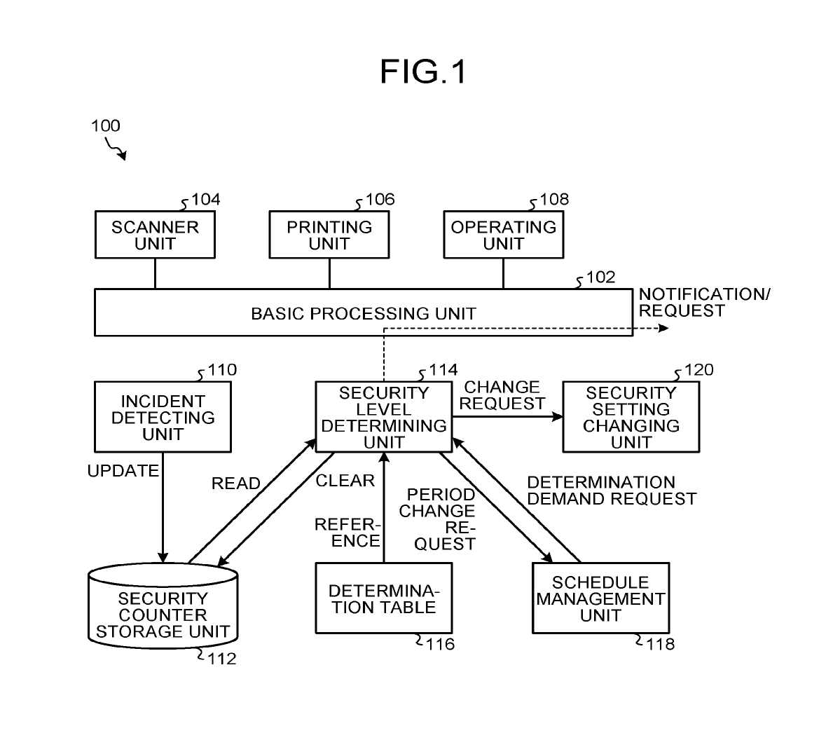

A security setting determination function implemented in the multifunction peripheral according to the first embodiment will be explained below with reference to FIG. 1 to FIG. 9. FIG. 1 is a functional block diagram of a configuration of the multifunction peripheral according to the first embodiment. FIG. 1 depicts flows of various pieces of information using arrows.

A multifunction peripheral 100 includes a basic processing unit 102, a scanner unit 104, a printing unit 106, and an operating unit 108. The multifunction peripheral 100 according to the present embodiment further includes an incident detecting unit 110, a security counter storage unit 112, a security level determining unit 114, a determination table 116, a schedule management unit 118, and a security setting changing unit 120.

The scanner unit 104 includes an image reading unit and performs image reading processing in the image processing services such as copying and scanning. The printing unit 106 includes an image forming unit and performs image forming processing in the image processing services such as copying and printing. The operating unit 108 includes a touch panel or the like operated by the operator and provides a user interface for accepting an operation input from the operator such as a login operation, a job execution instruction, or a logout operation. The basic processing unit 102 performs entire control including basic functions as the multifunction peripheral, such as the scanner unit 104, the printing unit 106, and the operating unit 108.

The embodiment illustrated in FIG. 1 represents the multifunction peripheral 100 that includes the scanner unit 104, the printing unit 106, and the operating unit 108; however, the configuration of the multifunction peripheral 100 is not particularly limited. For example, the multifunction peripheral may be provided with other function units such as a facsimile unit, or does not have to be provided with part of the function units. The multifunction peripheral 100 should include an appropriate function according to a specific use, a product design, or the like.

The incident detecting unit 110 is a detecting unit for detecting occurrence of a security incident in the multifunction peripheral 100. The security counter storage unit 112 stores security counters each of which is updated in response to detection of occurrence of a security incident. When detecting the occurrence of the security incident, the incident detecting unit 110 increments and updates a corresponding counter stored in the security counter storage unit 112. The security counter incremented in association with the occurrence of the incident constitutes an evaluating unit according to the present embodiment that evaluates an incident occurring in the environment that includes the multifunction peripheral 100.

For example, a lockout occurrence counter that counts occurrence of a lock-out evaluates an incident of password cracking by counting the number of occurrences of the lock-out. An auto logout occurrence counter for counting occurrence of an auto logout evaluates an incident of “forgetting to log out” by counting the number of occurrences of the auto logout. The security counter will be explained in detail later.

The security level determining unit 114 determines a setting level of each of security setting items in the multifunction peripheral 100. Each of the security setting items is associated with each incident. For example, a setting item of the lock-out function (including, for example, a set number of lock-out and a lock-out set time) is associated with the lockout occurrence counter (i.e. password cracking). A setting item of the auto logout function is associated with the auto logout occurrence counter (i.e. “forgetting to log out”). Each of the security setting items can include a plurality of levels, and the security level determining unit 114 determines one appropriate level among the levels. When an appropriate level is found out, the security level determining unit 114 makes a notification so that the set contents of the corresponding security setting item are changed to the determined setting level.

Here, the notification can be a notification that requests the security setting changing unit 120, explained later, to reflect the setting change without an operation of an administrator. Alternatively, the notification can be a notification that prompts the administrator associated with the multifunction peripheral 100 to manually perform the setting change or to approve the setting change. For example, the notification can be made so as to transmit an e-mail or an instant message including a uniform resource locator (URL) to call a setting change interface of the multifunction peripheral 100 to an address or an account of the administrator. The notification can be made through a network interface device of the basic processing unit 102.

The determination table 116 is data for describing a determination rule referred to by the security level determining unit 114. The determination rule is used to determine an appropriate setting level of each of the security setting items according to a current occurrence status of a security incident indicated by the security counter storage unit 112. The determination table 116 will be explained in detail later.

The schedule management unit 118 schedules the timing of determining the security setting and makes a determination demand request to the security level determining unit 114 in response to arrival of the timing. The scheduling may be performed in a fixed period in time units such as second, minute, hour, day, week, and month. Alternatively, in the exemplary embodiment, the scheduling may also be dynamically changed according to the current occurrence status of the security incident. In the exemplary embodiment where it is dynamically changed, the security level determining unit 114 determines a next timing of determining the security setting and transmits the timing as a period change request to the schedule management unit 118.

The security setting changing unit 120 provides an interface for changing the security setting. The security setting changing unit 120 changes the set contents so as to implement the security level of the requested security setting in response to the change request from the security level determining unit 114 or in response to the change instruction from the administrator. The security setting changing unit 120 constitutes a changing unit according to the present embodiment.

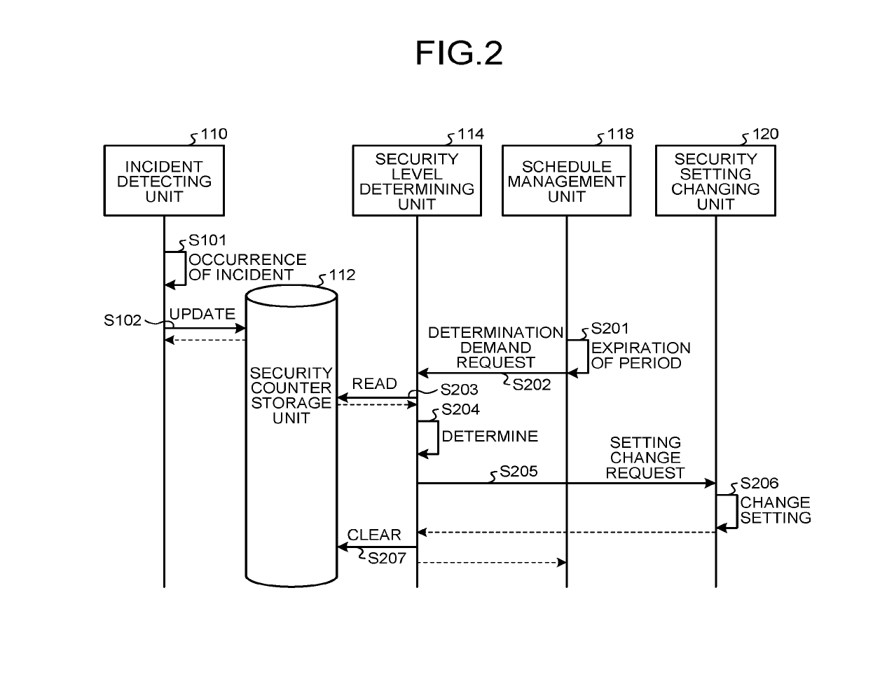

The function of each of the units will be explained below with reference to FIG. 2 using password cracking being one of login attacks as an example. FIG. 2 is a sequence diagram of security setting determination processing performed by the multifunction peripheral 100 according to the first embodiment.

Typical password cracking is an attack to randomly change a password for a login name and to allow a login if the passwords match each other by chance. Against this attack, there is a lock-out function so as to temporarily prevent a login operation when the login failure occurs the predetermined number of times consecutively.

At Step S101, the incident detecting unit 110 detects that the login failure occurs the predetermined number of times consecutively, performs lockout processing, and, at Step S102, updates the lockout occurrence counter in the security counter storage unit 112 by being incremented by one. Thereby, the occurrence status of the security incident in the multifunction peripheral 100 is evaluated.

When detecting expiration of a predetermined period (e.g., one week) at Step S201, then at Step S202, the schedule management unit 118 makes a determination demand request to the security level determining unit 114. At Step S203, the security level determining unit 114 reads a value of the lockout occurrence counter from the security counter storage unit 112 in response to the determination demand request.

At Step S204, the security level determining unit 114 compares the read value of the lockout occurrence counter and the separately read determination table 116, and determines a setting level to be set for each security setting item of the lock-out function. At Step S205, the security level determining unit 114 notifies the security setting changing unit 120 of a change request to the determined setting level. At Step S206, the security setting changing unit 120 changes the set value of the security setting item to the requested value in response to the change request. At Step S207, the security level determining unit 114 clears the lockout occurrence counter and ends the processing. Such a flow as above is a basic processing flow.

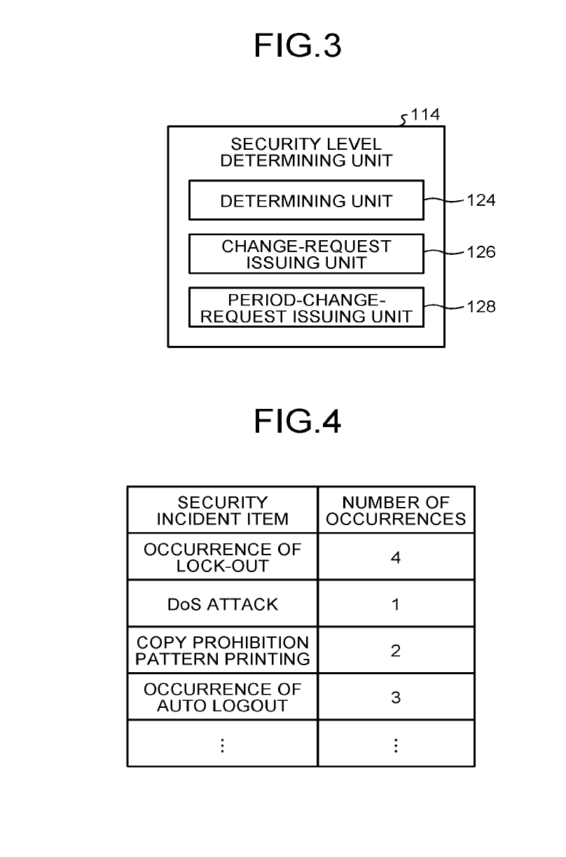

A more detail configuration of the security level determining unit 114 will be explained below with reference to FIG. 3 to FIGS. 7A and 7B. FIG. 3 is a functional block diagram of a detailed configuration of the security level determining unit 114 in the multifunction peripheral 100 according to the first embodiment. As illustrated in FIG. 3, the security level determining unit 114 includes a determining unit 124 and a change-request issuing unit 126, and may further include a period-change-request issuing unit 128.

The determining unit 124 constitutes a determining unit according to the present embodiment that reads the value of each security counter from the security counter storage unit 112 and refers to the determination table 116 to determine a setting level of each security setting item. The change-request issuing unit 126 constitutes a change notifying unit and a change-request issuing unit according to the present embodiment that issue a change request to the security setting changing unit 120 of the multifunction peripheral 100 based on the determination performed by the determining unit 124. As explained above, when the notification is made to the administrator, a change requesting unit for making a change request to a contact address of the registered administrator associated with the multifunction peripheral 100 may be provided instead of the change-request issuing unit 126.

FIG. 4 is a diagram of an example of a data structure of the security counter referred to by the security level determining unit 114 in the multifunction peripheral 100 according to the first embodiment. As illustrated in FIG. 4, the information managed by the security counter storage unit 112 includes a security incident item and the number of occurrences of the incident. Herein, the security incident item is determined in advance. The number of occurrences is incremented by one each time the security incident occurs in a predetermined evaluation period, and is continuously increased until it is cleared by the security level determining unit 114 after completion of the determination.

Security incident items are managed by item, and the number of detections of a denial of service (DoS) attack and the number of detections of violation in pattern printing, or the like, can be exemplified in addition to the number of occurrences of lock-out and the number of occurrences of auto logout. To simplify the management, each item is independently managed, and only the number of occurrences of a relevant incident is simply managed based on the fact that it is not affected by other incidents. However, in other embodiments, the management does not prevent evaluation of a plurality of incident items in combination thereof.

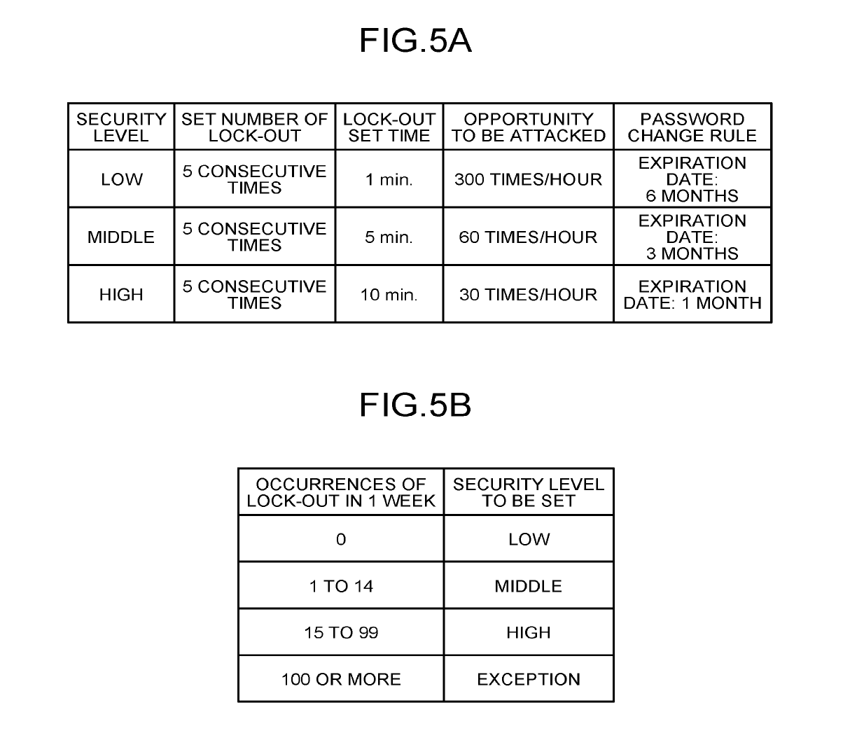

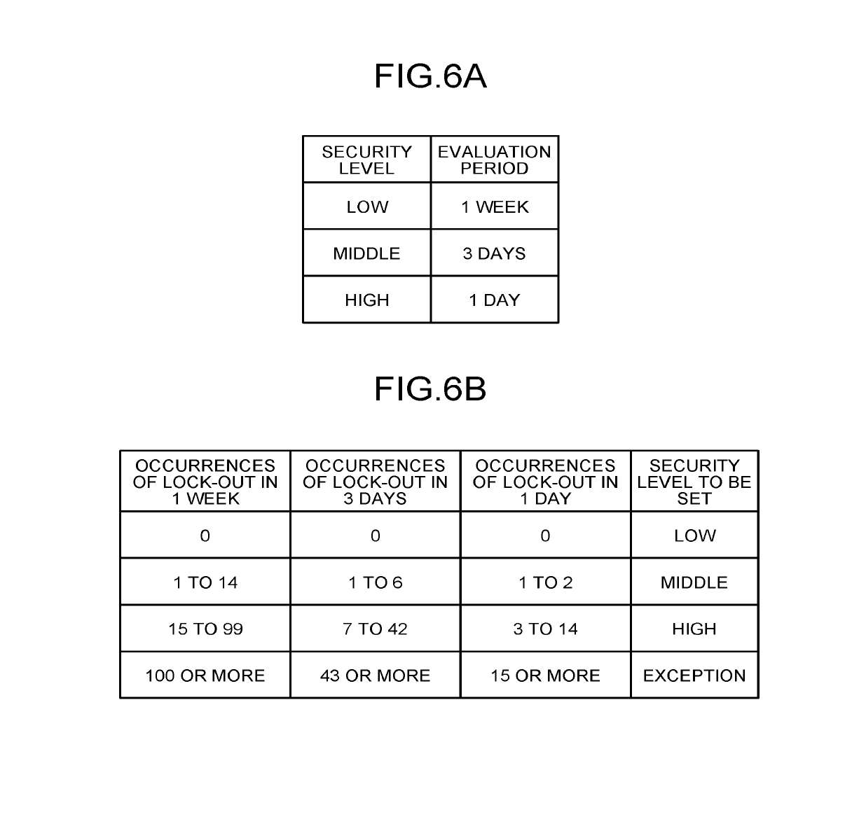

FIGS. 5A and 5B to FIGS. 7A and 7B are diagrams of examples of the data structure of the determination table 116 referred to by the security level determining unit 114 in the multifunction peripheral 100 according to the first embodiment. FIGS. 5A and 5B and FIGS. 6A and 6B define lock-out settings for the password cracking.

The determination table illustrated in FIG. 5A is a determination table when the security level is defined in three stages. The security strength of the lock-out function is determined mainly by the set number of lock-out and the lock-out set time; however, in the embodiment described below, for the sake of convenience in description, it is assumed that the set number is fixed and only the lock-out set time is a target for change. In other words, for the lock-out function, an appropriate level for only the lock-out set time is determined from the security levels defined in the three stages. However, in other embodiments, a plurality of levels may be provided for the set number in addition to or instead of the set time, or a plurality of combined levels may be provided for a combination of the set number and the set time.

In the example of FIG. 5A, the security level “low” represents a setting in which if a password error reaches 5 consecutive times, the access is stopped for one minute. As a supplement, an opportunity to be attacked and a password change rule are described in FIG. 5A.

The opportunity to be attacked mentioned here represents how often a login can be attempted in one hour. The less the value is, the more the opportunity for an attacker to attempt is reduced, and it can therefore be said that the security strength is high. For example, for the level “low” in the determination table of FIG. 5A, because five login attempts per minute are allowed, the opportunity to be attacked can be estimated as 300 times/hour (=5 times×60 tries). However, in the estimation, it is assumed that a login action time itself for five times is sufficiently shorter than the lock-out set time, and therefore the calculation is not considered. Likewise, if the level is “middle”, 60 times/hour (=5 times×12 tries), and if the level is “high”, 30 times/hour (=5 times×6 tries).

Regarding the password change rule, the password needs to be changed in a short period of time if the attack is frequent, but if the attack is not so frequent, it can be said that a relatively long time is sufficient for the change. In a specific embodiment, by changing the password change rule according to each level, it is possible for the user to save the trouble of having to change his/her password more than necessary. Such an operation can be performed by sending a notification by mail to the administrator in order to prompt him/her to change the password.

The determination table illustrated in FIG. 5B is a determination table that stores a setting level to be set in association with an actual number of occurrences of lock-out. By referring to the determination table illustrated in FIG. 5B, it is possible to determine which security level is to be set depending on how often the lock-out occurs.

In the example of FIG. 5B, the setting level is described in association with a range of the occurrences based on one week as the evaluation period. For example, when the number of occurrences of lock-out in one week is 4 times, it falls within a range of 1 to 14 times, and it is therefore determined that the security level is “middle”. Then, it is determined that the lock-out set time should be “5 minutes” from the table illustrated in FIG. 5A.

The determining unit 124 can determine whether exception processing is to be called based on the evaluation result of the security incident. “Exception” in the determination table illustrated in FIG. 5B is used for calling the exception processing when the counter value is determined as abnormal. The example of FIG. 5B represents that when the number of occurrences of lock-out in one week is 100 times or more, it is determined that this value is an abnormal value which is different from normal and the corresponding exception processing is to be performed. Taking the password cracking as an example, if the counter value is “1000” or so, it is conceivable that a serious situation obviously occurs. In this case, the exception processing for stopping the use of the device itself can be performed in such a manner that, based on the determination of the determining unit 124, the unit itself turns off the power or the unit stops network login processing.

In security measures, real-time is important in some cases. For example, when the password cracking is intensively performed, checking for each week may be insufficient. However, by simply setting the evaluation period to be shorter, resources and their power consumption become waste if the incident hardly occurs.

Therefore, in the exemplary embodiment, the determining unit 124 can determine a timing in which determination of security setting is started next time based on the evaluation result of the security incident (the number of occurrences per unit period). For example, when no security incident occurs, the timing can be delayed, while when the incident occurs, the timing can be advanced. The period-change-request issuing unit 128 illustrated in FIG. 3 is used in the exemplary embodiment, and issues a period change request to change the period to the determined period to the schedule management unit 118 so as to set the next start timing. In this case, the schedule management unit 118 calls the security level determining unit 114 at the newly set timing.

FIGS. 6A and 6B explain determination tables when the scheduling is dynamically performed. The determination table illustrated in FIG. 6A defines the security level in the three stages and associates an evaluation period with each of the levels. The determination table illustrated in FIG. 6B is data for dividing cases for each possible evaluation period and storing a setting level to be set in association with an actual number of occurrences of lock-out. In the example of FIG. 6B, a range of the occurrences for each evaluation period is converted to a one-week evaluation period and is set so as to become roughly the same value as each other. Thus, the evaluation period can be changed while adopting substantially the same determination criteria.

Specifically, for example, the level that the occurrences from 1 time to 14 times in one week are determined as “middle” is divided by 7 days, and the occurrences from 1 time to 2 times in one day are determined as “middle”. The level that the occurrences from 15 times to 99 times in one week are determined as “high” is divided by 7 days, and the occurrences from 3 times to 14 times in one day are determined as “high”. Thus, if the frequency of occurrence increases, the evaluation is performed in a short period while being substantially the same determination criteria, so that the level changed after one week at maximum will be changed in one day at the shortest.

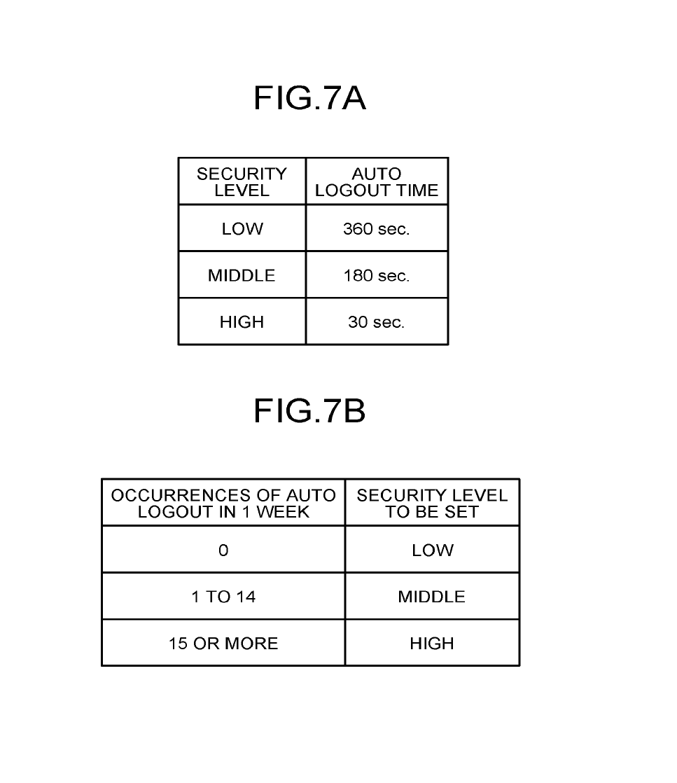

FIG. 7A and FIG. 7B define auto logout time setting for the auto logout function. “Forgetting to log out” indicates a case where the user logs in the multifunction peripheral 100 through the operating unit 108 and uses the copying or facsimile service, and then walks away without manually logging out. When “forgetting to log out” occurs, this allows someone else to perform an operation by the operator's authority without performing a login operation. The auto logout function is provided as measures against the “forgetting to log out”. When the logout is not performed even after elapse of a specified time since the last operation performed on the operating unit 108, the logout processing is carried out automatically.

In terms of the security strength, it can be said that the shorter this time is, the more secure the security will be. However, when the logout time to log out automatically becomes too short, logout easily occurs in the middle of performing selection at an operation panel, and convenience thereby decreases. On the other hand, when the logout time is set to be long, the login status is maintained a longer time after the operator leaves the multifunction peripheral, which leads to an increase in probability that it may be operated by someone else using the operator's account.

The determination table illustrated in FIG. 7A is a determination table when the security level is defined in the three stages. The determination table illustrated in FIG. 7B is data for storing a setting level to be set in association with an actual number of occurrences of auto logout. By referring to the determination table illustrated in FIG. 7B, it is possible to determine which security level is to be set depending on how often the auto logout occurs.

In the example of FIG. 7B, the setting level is described in association with a range of the occurrences based on one week as the evaluation period. Herein, when “forgetting to log out” does not occur, a comparatively long time (“360 sec.”) is set, while when “forgetting to log out” occurs frequently, a comparatively short time (“30 sec.”) is set. For example, when the number of occurrences of auto logout in one week is 4 times, it falls within a range of 1 to 14 times, and it is therefore determined that the security level is “middle”. Then, it is determined that the auto logout time should be “180 sec.” from the table illustrated in FIG. 7A.

In the present embodiment, based on the determination tables illustrated in FIGS. 5A and 5B to FIGS. 7A and 7B, it can be configured not only to increase the security strength from the current setting level to security strength higher than the current setting level, but also to change the setting level to a setting level at which the security strength is reduced more than that of the current setting level. The determination tables illustrated in FIGS. 5A and 5B to FIGS. 7A and 7B are examples used to determine security setting items of the lock-out function and the auto logout function respectively corresponding to incidents of the password cracking and the forgetting to log out. These determination tables are also applied to other security incidents such as DoS attacks and the number of detections of violation in pattern printing.

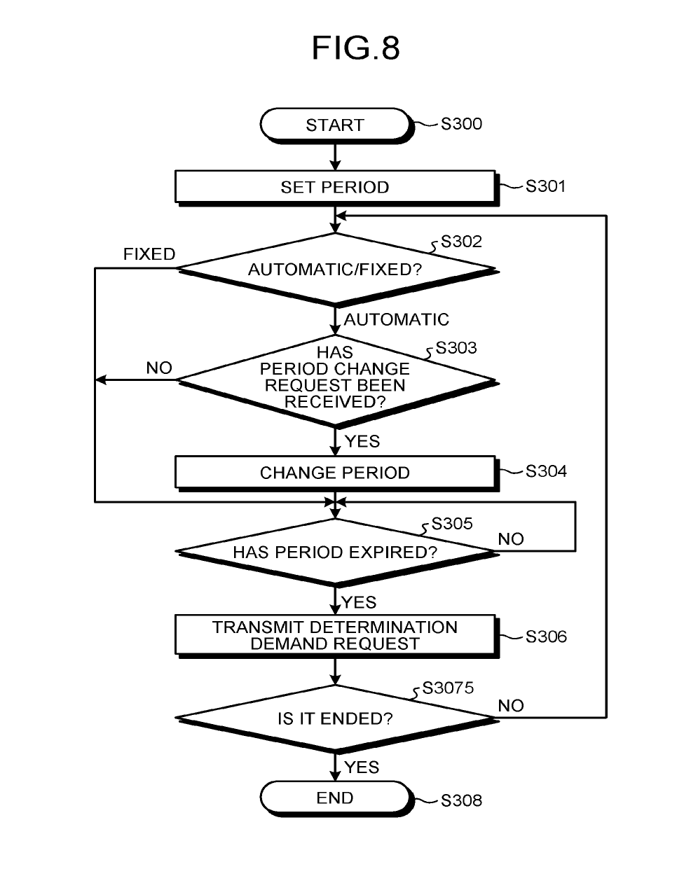

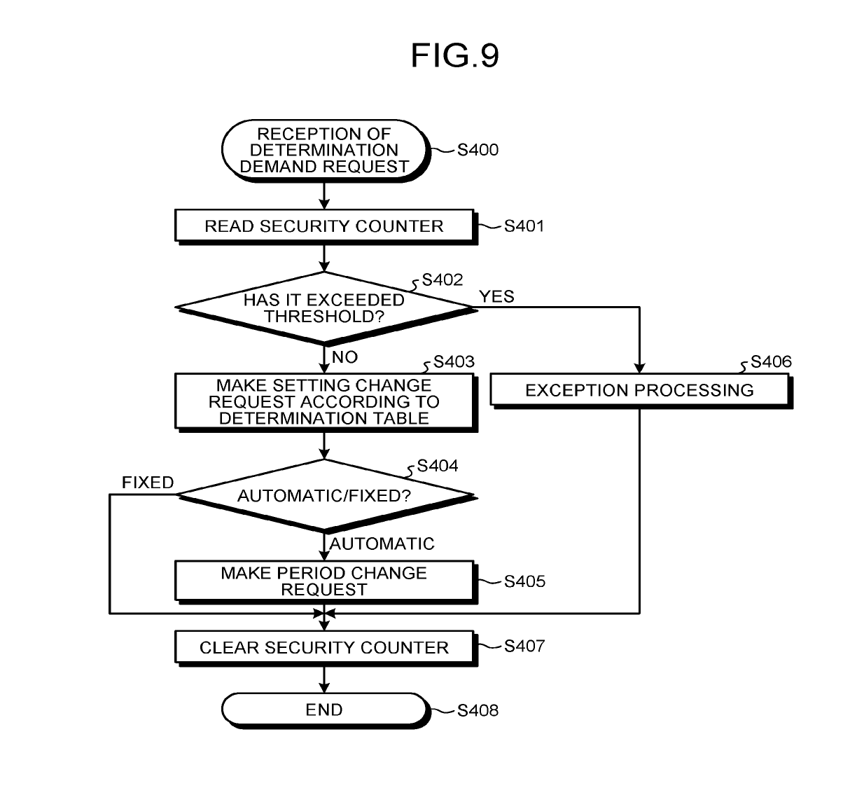

A security setting determination routine implemented by the schedule management unit 118 and the security level determining unit 114 operating in cooperation with each other will be explained below with reference to FIG. 8 and FIG. 9.

FIG. 8 is a flowchart of processing performed by the schedule management unit 118 in the multifunction peripheral 100 according to the first embodiment. The processing illustrated in FIG. 8 is started at Step S300, for example, in response to turn-on of power of the multifunction peripheral 100 or in response to reception of an explicit instruction from the administrator.

At Step S301, the schedule management unit 118 reads a set value of a schedule related to security setting determination processing, and performs period settings. The settings include (1) selection of either one of “fixed” and “automatic”, and (2) selection of a fixed period if “fixed” is selected and selection of an initial period if “automatic” is selected. For the fixed period or the initial period, an evaluation period such as one week or one month and a period until when the evaluation is repeated are set. When automatic is selected, a dynamic change, according to the exemplary embodiment, which corresponds to the current occurrence status of the security incident, is enabled. The settings are carried out by the administrator in advance.

At Step S302, the processing is branched according to whether the period setting is automatic or fixed. At Step S302, when the period setting is automatic (Automatic), the processing is branched to Step S303. At Step S303, the schedule management unit 118 determines whether a period change request has been received. When it is determined that the period change request has been received at Step S303 (YES), the processing is branched to Step S304. At Step S304, the period setting is changed to a specified period included in the period change request.

On the other hand, when it is determined that the period change request has not been received at Step S303 (NO), the processing is branched to Step S305. In a first loop immediately after the start of the present processing, because the security setting determination processing is not yet called, the processing is generally branched to Step S305 without receiving the period change request. At Step S302, when the period setting is fixed (Fixed), the processing is directly branched to Step S305.

After the scheduling is started, at Step S305, it is periodically determined whether the set period has expired. When it is determined that the period has not expired at Step S305 (NO), Step S305 is repeated during “NO” after a given waiting time. Meanwhile, when it is determined that the period has expired at Step S305 (YES), the processing is branched to Step S306. At Step S306, the schedule management unit 118 transmits a determination demand request to the security level determining unit 114.

At Step S307, it is determined whether the end time of the schedule has been reached. When it is determined that the end time of the schedule has not been reached at Step S307 (NO), the processing is looped to Step S302, and the processing is repeated. Meanwhile, when it is determined that the end time of the schedule has been reached at Step S307 (YES), the processing is branched to Step S308, and the present processing is ended.

FIG. 9 is a flowchart of processing performed by the security level determining unit 114 in the multifunction peripheral 100 according to the present embodiment. The processing illustrated in FIG. 9 is started at Step S400 in response to the fact that the security level determining unit 114 receives the determination demand request transmitted from the security level determining unit 114 at Step S306 illustrated in FIG. 8.

At Step S401, the security level determining unit 114 reads a value of a predetermined security counter (e.g., the lock-out occurrence counter) from the security counter storage unit 112. At Step S402, the security level determining unit 114 compares the read counter value and the determination table and determines whether the counter value has exceeded a threshold for calling the exception processing. When it is determined that the counter value has not exceeded the threshold for calling the exception processing at Step S402 (NO), the processing is branched to Step S403.

At Step S403, the security level determining unit 114 determines an appropriate setting level according to the determination table, and notifies the security setting changing unit 120 of a setting change request. At Step S404, the security level determining unit 114 further branch the processing according to whether the period setting is automatic or fixed. At Step S404, when the period setting is automatic (Automatic), the processing is branched to Step S405. At Step S405, the security level determining unit 114 determines an evaluation period appropriate for the current status based on the determination table and issues the period change request to the schedule management unit 118, and the processing proceeds to Step S407. The period change request is used in the determination at Step S303 of FIG. 8.

At Step S407, the security level determining unit 114 clears the value of the predetermined security counter (e.g., the lock-out occurrence counter) in the security counter storage unit 112 and ends the processing at Step S408.

When it is determined that the called counter value has exceeded the threshold for calling the exception processing at Step S402 (YES), the processing is branched to Step S406. At Step S406, the security level determining unit 114 performs the exception processing such that the unit itself turns off the power or the unit stops network login processing, and the processing proceeds to Step S407.

In the multifunction peripheral 100 according to the first embodiment, an appropriate level of a relevant security setting item in the multifunction peripheral is determined by analyzing the security counter for evaluating the security incident of the environment where the multifunction peripheral 100 is used. For an incident predicted that there is an attack, the level of the relevant security setting item in the multifunction peripheral is increased. On the other hand, for an incident predicted that there is no attack, the level of the relevant security setting item in the multifunction peripheral is decreased. Therefore, it is possible to determine the appropriate setting level according to the actually detected incident in the environment where the multifunction peripheral 100 is used.

The first embodiment has explained the multifunction peripheral, as an example of the information processing system, that provides the image processing services, allows a security incident to be generated, and has the determination function for the security settings of its own. However, the configuration of the information processing system is not limited thereto. In other embodiments, a security setting determination function can also be provided in an information processing device separately disposed from the multifunction peripheral that provides image processing services. Such other embodiments will be explained below.

In a second embodiment explained below, as the information processing system, a security system 200 will be explained as an example, the security system 200 including a multifunction peripheral 210 in which a security incident occurs, and a security analysis device 250 that evaluates an incident occurring in the multifunction peripheral 210 and determines an appropriate setting level of each security setting item of the multifunction peripheral 210. The second embodiment has some portions similar to these of the first embodiment, and therefore some different points will particularly be explained. The security analysis device 250 constitutes a setting determination device according to the present embodiment.

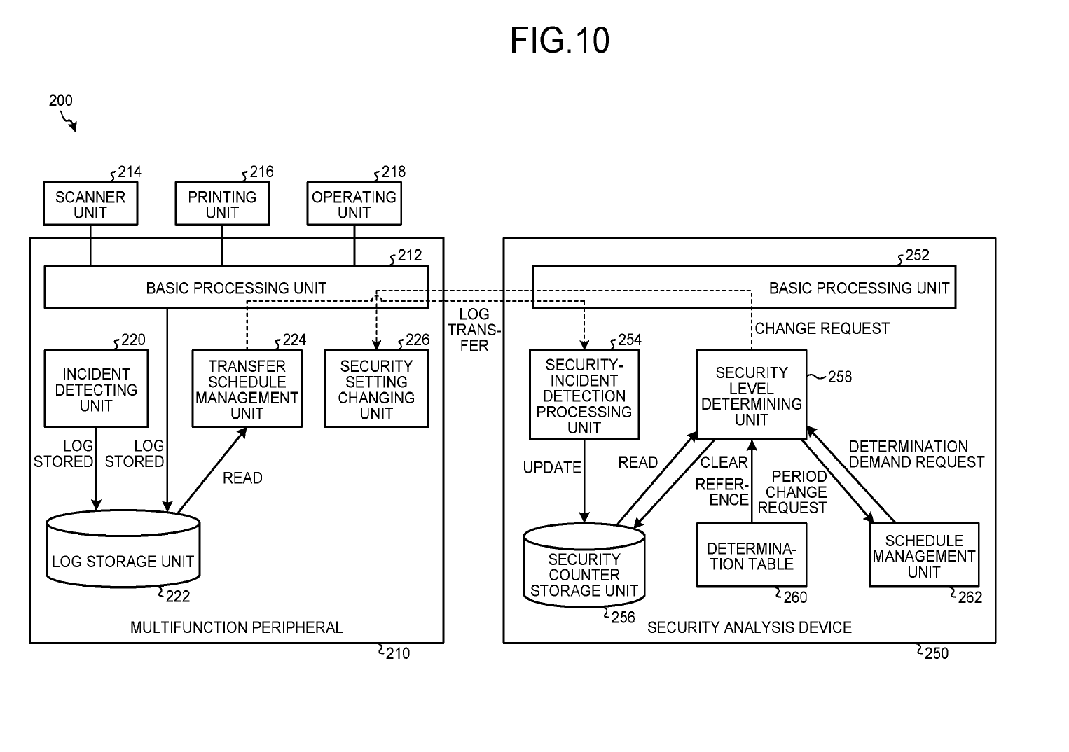

FIG. 10 is a functional block diagram of a configuration of the security system 200 including the multifunction peripheral 210 and the security analysis device 250 according to the second embodiment. The multifunction peripheral 210 includes a basic processing unit 212, a scanner unit 214, a printing unit 216, and an operating unit 218, similarly to the first embodiment. The basic processing unit 212, the scanner unit 214, the printing unit 216, and the operating unit 218 are the same as these of the first embodiment, and explanation thereof is therefore omitted.

The multifunction peripheral 210 according to the present embodiment further includes an incident detecting unit 220, a log storage unit 222, a transfer schedule management unit 224, and a security setting changing unit 226.

The incident detecting unit 220 is a detecting unit that detects occurrence of a security incident in the multifunction peripheral 210. In the second embodiment, events such as a security incident occurring in the multifunction peripheral 210 are stored in a hard disk or a nonvolatile memory of the multifunction peripheral 210 in the form of logging. In this case, in a case in which the incident detecting unit 220 for detecting occurrence of a lock-out in response to consecutive failures is provided and also in a case in which a login error or the like is merely detected without providing the incident detecting unit 220, all of the cases are stored as logs in the log storage unit 222 in the same way as each other.

The transfer schedule management unit 224 has a function of transferring the stored logs to an external server that manages logs, periodically or when the logs reach a predetermined standard such that the logs of a give standard amount of data are stored. In the present embodiment, the security analysis device 250 is included in a destination server. The security setting changing unit 226 is a module that operates through an interface for performing security settings of the multifunction peripheral 210 from an external device including such as a personal computer in the same manner as that of the first embodiment.

The security analysis device 250 includes a basic processing unit 252, a security-incident detection processing unit 254, a security counter storage unit 256, a security level determining unit 258, a determination table 260, and a schedule management unit 262.

The security counter storage unit 256 stores, similarly to the first embodiment, security counters each of which is updated in response to detection of occurrence of a security incident. However, in the second embodiment, to extract a security counter, the security-incident detection processing unit 254 analyzes the logs transferred from the multifunction peripheral 210. When detecting occurrence of the security incident as a result of log analysis, the security-incident detection processing unit 254 increments and updates the corresponding counter stored in the security counter storage unit 256. When occurrence of lock-out is recorded as a log, the counter is incremented without any change. Even if there is no log of occurrence of lock-out, for example, when a password input error occurs a reference number of occurrences consecutively, it is regarded that the incident of the password cracking occurs and the counter is incremented.

The security level determining unit 258, the determination table 260, and the schedule management unit 262 are the same as the security level determining unit 114, the determination table 116, and the schedule management unit 118, which are explained in the first embodiment. However, the security level determining unit 258 transmits a security setting change request to the multifunction peripheral 210 through the network because the multifunction peripheral 210 as a determination target is provided externally.

In the second embodiment, a single security analysis device 250 is provided for a single multifunction peripheral 210; however, the embodiments are not limited thereto. In another embodiment, a plurality of multifunction peripherals may be set as a management target for the security analysis device. In this case, the security analysis device may be configured to determine independently the security setting in each multifunction peripheral, or to evaluate occurrence of security incidents in the whole environment where the multifunction peripherals are used, and to determine an appropriate setting level of each security setting item for each multifunction peripheral, for each group of the multifunction peripherals, or for the whole based on the evaluation as a whole environment. The function units of the security analysis device 250 are implemented on a single information processing device, and may also be mounted on a plurality of information processing devices in a parallel manner or in a dispersed manner.

In a third embodiment described herein below, similarly to the second embodiment, a security system 300 including a multifunction peripheral 310 and a security analysis device 350 will be explained as an example of the information processing system. The third embodiment has a portion similar to the second embodiment, and therefore some different points in particular are mainly explained.

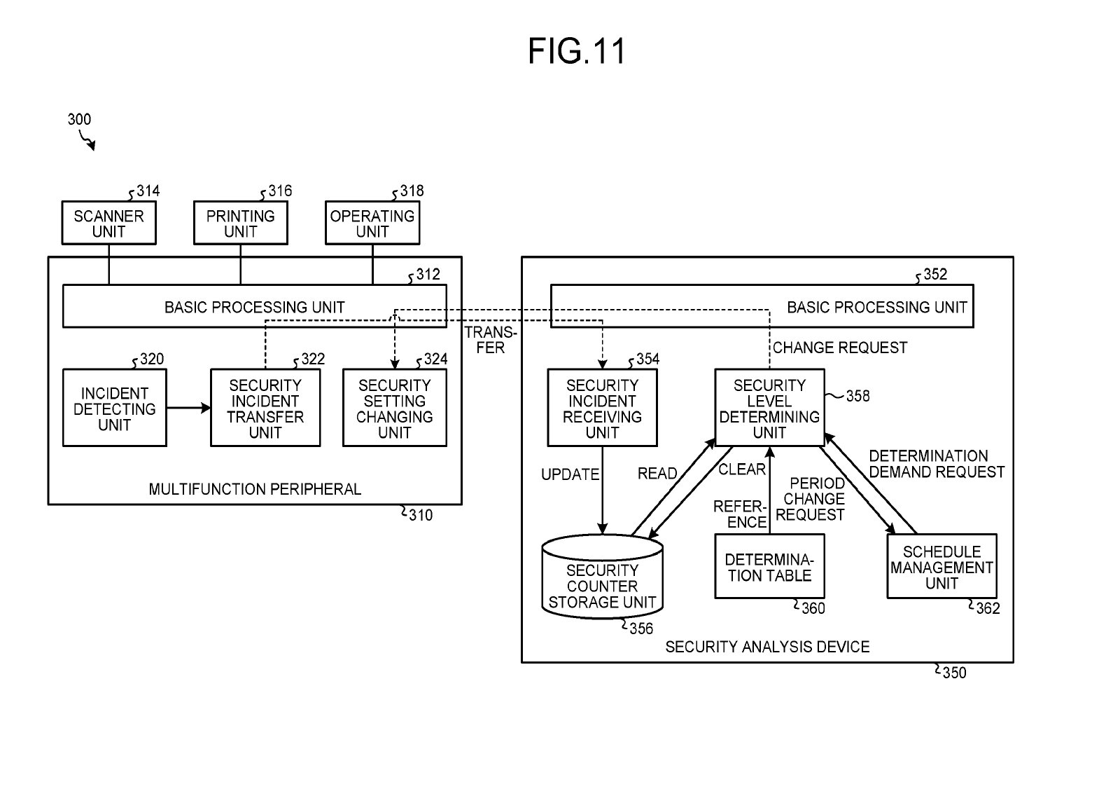

FIG. 11 is a functional block diagram of a configuration of the security system 300 including the multifunction peripheral 310 and the security analysis device 350 according to the third embodiment. The multifunction peripheral 310 includes, similarly to the second embodiment, a basic processing unit 312, a scanner unit 314, a printing unit 316, and an operating unit 318. The multifunction peripheral 310 according to the present embodiment further includes an incident detecting unit 320, a security incident transfer unit 322, and a security setting changing unit 324.

The incident detecting unit 220 is a detecting unit that detects occurrence of a security incident in the multifunction peripheral 210. When a security incident occurs in the multifunction peripheral 310, the security incident transfer unit 322 transfers the information without any change to an external destination in real-time. The destination includes the security analysis device 350. The security setting changing unit 324 is the same as that of the first embodiment and the second embodiment.

The security analysis device 350 includes a basic processing unit 352, a security incident receiving unit 354, a security counter storage unit 356, a security level determining unit 358, a determination table 360, and a schedule management unit 362. The security analysis device 350 according to the third embodiment does not need to analyze a log and updates a relevant counter stored in the security counter storage unit 356 based on the real-time incident information received by the security incident receiving unit 354 in the same manner as that of the first embodiment.

The security level determining unit 358, the determination table 360, and the schedule management unit 362 are the same as these explained in the first embodiment. However, similarly to the second embodiment, the security level determining unit 358 transmits a security setting change request to the multifunction peripheral 310 through the network because multifunction peripheral 310 as a determination target is provided externally.

In the third embodiment, similarly to the second embodiment, a plurality of multifunction peripherals may be set as a management target for the security analysis device. The function units of the security analysis device 250 are implemented on a single information processing device, and may also be mounted on a plurality of information processing devices in a parallel manner or in a dispersed manner.

In the embodiments described so far, the multifunction peripheral has been explained as an example of the information processing device as a determination target of security setting. However, the information processing device that can be a determination target is not particularly limited. In addition to the multifunction peripheral, any electronic apparatus connected to the network can be the target, such as image forming apparatuses such as a printer and a copier, image reading devices such as a scanner, image communication devices such as a facsimile, video projection devices such as a projector, video display devices such as a display, electronic conference terminals, electronic whiteboards, mobile information terminals, imaging devices, vending machines, medical equipment, air conditioning systems, metering devices for gas, water, and electricity etc., and networked home appliances such as a refrigerator and a washing machine.

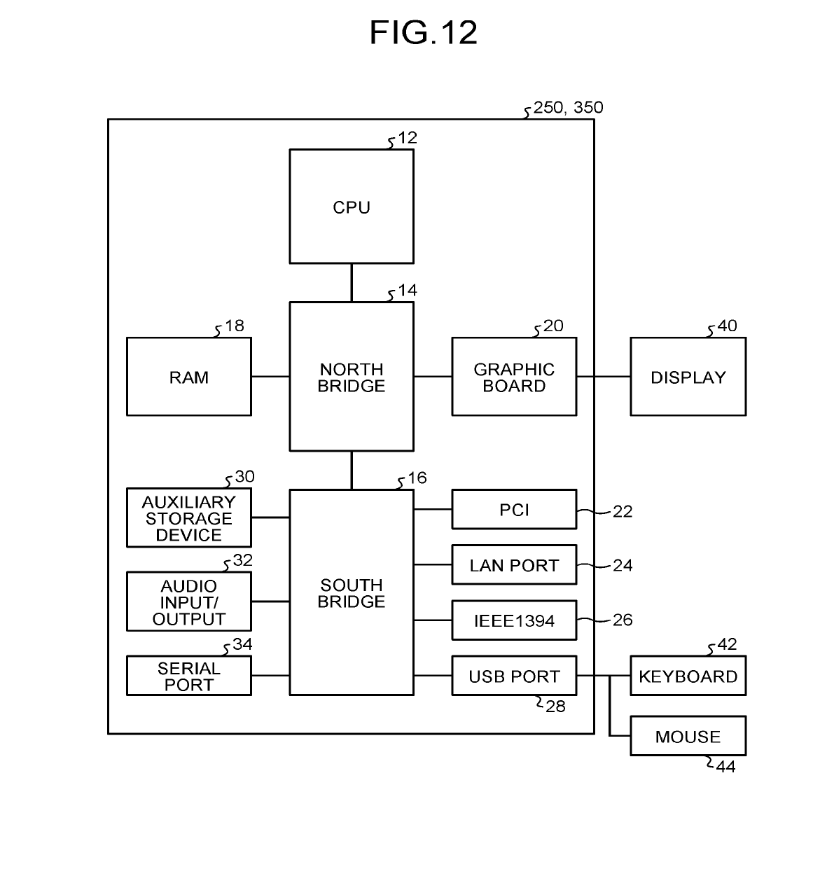

A hardware configuration of the security analysis device (250 of 250 and 350 is explained below as its typical one) according to the present embodiment will be explained below with reference to FIG. 12. FIG. 12 is a diagram of the hardware configuration of the security analysis device 250 according to the present embodiment. The security analysis device 250 according to the present embodiment is configured as a general-purpose computer or the like such as a desktop personal computer and a work station. The security analysis device 250 illustrated in FIG. 12 includes a central processing unit (CPU) 12, a north bridge 14 that functions as a connection between the CPU 12 and a memory, and a south bridge 16 that functions as a connection between input/output (I/O) of a PCI bus and I/O of USB.

Connected to the north bridge 14 are a random access memory (RAM) 18 that provides a work area of the CPU 12 and a graphic board 20 that outputs a video signal. A display 40 is connected to the graphic board 20 through a video output interface.

Connected to the south bridge 16 are an auxiliary storage device 30 such as a peripheral component interconnect (PCI) 22, a local area network (LAN) port 24, the Institute of Electrical and Electronics Engineers, Inc. 1394 (IEEE 1394) 26, a Universal Serial Bus (USB) port 28, a hard disk drive (HDD), and a solid state drive (SSD); an audio input/output 32; and a serial port 34. The auxiliary storage device 30 stores an operating system (OS) for controlling a computer device, a control program for implementing the function units, various system information, and various setting information. The LAN port 24 is an interface device for connecting the security analysis device 250 to LAN.

The USB port 28 may be connected with an input device such as a keyboard 42 and a mouse 44, and is capable of providing a user interface for accepting an input of various instructions issued from the operator of the security analysis device 250. The security analysis device 250 according to the present embodiment reads the control program from the auxiliary storage device 30 and loads it into a workspace provided by the RAM 18, to thereby implement the function units and each processing under the control of the CPU 12.

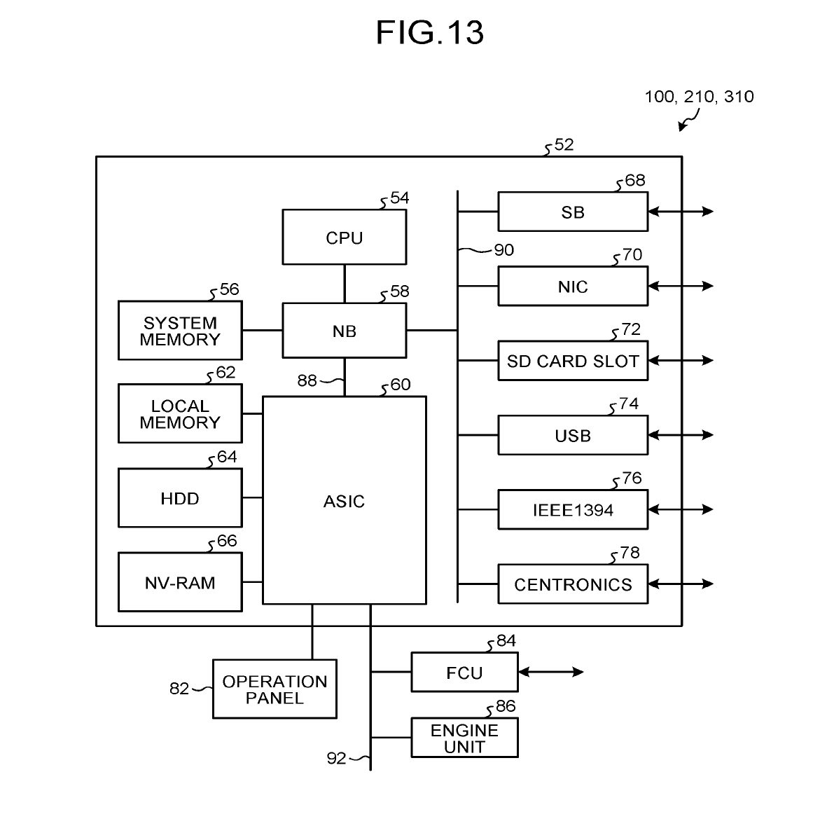

FIG. 13 represents an embodiment of the hardware configuration of the multifunction peripheral (which will be explained below using 100 as a typical one among 100, 210, and 310). The multifunction peripheral 100 includes a controller 52, an operation panel 82, a facsimile control unit (FCU) 84, and an engine unit 86. The controller 52 includes a CPU 54, a north bridge (NB) 58, an application specific integrated circuit (ASIC) 60 connected to the CPU 54 through the NB 58, and a system memory 56. The ASIC 60 performs various types of image processing, and is connected to the NB 58 through an accelerated graphics port (AGP) 88. The system memory 56 is used as a drawing memory and the like.

The ASIC 60 is connected to a local memory 62, a hard disk drive 64, and a nonvolatile memory (hereinafter, referred to as NV-RAM) 66 such as a flash memory. The local memory 62 is used as an image buffer for copying and a code buffer. The HDD 64 is a storage that stores image data, document data, programs, font data, and form data. The NV-RAM 66 stores programs for controlling the multifunction peripheral 100, various system information, and various setting information.

The controller 52 further includes a south bridge (SB) 68, a network interface card (NIC) 70, a secure digital (SD) card slot 72, a USB interface 74, an IEEE 1394 interface 76, and a Centronics interface 78, which are connected to the NB 58 through the PCI bus 90. The SB 68 is a bridge for connecting a ROM and PCI-bus peripheral devices, which are not illustrated, and the NB 58. The NIC 70 is an interface device that connects the multifunction peripheral 100 to a network such as the Internet or the LAN, and accepts an instruction through the network. An SD card (not illustrated) is detachably attached to the SD card slot 72. The USB interface 74, the IEEE 1394 interface 76, and the Centronics interface 78 are interfaces based on the respective standards, and accept print jobs and the like.

The operation panel 82 being a display unit provides an user interface connected to the ASIC 60 of the controller 52 and used to accept each input of various instructions from the operator and perform image display. The FCU 84 and the engine unit 86 are connected with the ASIC 60 through a PCI bus 92. The FCU 84 performs a communication method based on a facsimile communication standard such as G3 or G4. The engine unit 86 receives a printing instruction or a scanning instruction issued by the application and performs image forming processing or image reading processing. The engine unit 86 constitutes a scanner unit and a printing unit.

As explained above, according to the present embodiment, it is possible to provide the information processing system, the information processing device, the setting determination method, and the program capable of determining a setting level of the security setting corresponding to an incident of the information processing device according to the incident actually detected in the environment where the information processing device is used.

The function units can be implemented by a computer-executable program written in a legacy programming language, an object-oriented programming language, or the like, such as Assembler, C, C++, C#, and Java. The program can be distributed by being stored in a device-readable recording medium such as ROM, EEPROM, EPROM, flash memory, flexible disk, CD-ROM, CD-RW, DVD-ROM, DVD-RAM, DVD-RW, Blu-ray disc, SD card, and MO, or distributed through an electric communication line.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system that determines security setting of an information processing device, comprising:
an evaluating unit that evaluates an incident occurring in an environment that includes the information processing device;
a determining unit that determines a setting level, of a plurality of levels, for the security setting corresponding to the incident of the information processing device based on an evaluation result of the incident by the evaluating unit; and
a changing unit that changes the security setting corresponding to the incident of the information processing device to security setting corresponding to the setting level determined by the determining unit.

2. The information processing system according to claim 1, further comprising:
either one of a change-request issuing unit that issues a change request to the information processing device so as to change the security setting to the security setting corresponding to the setting level determined by the determining unit, and a change requesting unit that requests a registered administrator associated with the information processing device so as to change the security setting to the security setting corresponding to the setting level determined by the determining unit.

3. The information processing system according to claim 2, wherein the information processing device includes the changing unit, and
the changing unit changes the security setting corresponding to the incident to the setting level in response to either one of the change request issued from the change-request issuing unit and an instruction from the administrator corresponding to the request made by the change requesting unit.

4. The information processing system according to claim 1, wherein the determining unit determines a timing of starting next evaluation of the incident.

5. The information processing system according to claim 1, wherein the determining unit determines whether to call exception processing based on the evaluation result of the incident.

6. The information processing system according to claim 1, wherein the change of the security setting includes a change from a current setting level to a setting level at which security strength is reduced more than the current setting level.

7. The information processing system according to claim 1, further comprising:
a detecting unit that detects occurrence of the incident in the environment that includes the information processing device, wherein
the incident occurring in the environment that includes the information processing device is related to a security threat.

8. The information processing system according to claim 1, wherein the evaluating unit and the determining unit are included in either one of the information processing device and another information processing device different from the information processing device.

9. An information processing device that determines own security setting, comprising:
an evaluating unit that evaluates an incident occurring in an environment that includes the information processing device;
a determining unit that determines a setting level, of a plurality of levels, for the security setting corresponding to the incident of the information processing device based on an evaluation result of the incident by the evaluating unit; and
a changing unit that changes the security setting corresponding to the incident of the information processing device to security setting corresponding to the setting level determined by the determining unit.

10. The information processing device according to claim 9, wherein the changing unit reflects a change of the security setting in response to either one of a determination result by the determining unit and an instruction of an administrator based on the determination result of the determining unit.

11. A setting determination method of determining security setting of an information processing device, the setting determination method comprising:
evaluating an incident occurring in an environment that includes the information processing device;
determining a setting level, of a plurality of levels, for the security setting corresponding to the incident of the information processing device based on an evaluation result of the incident evaluated at the evaluating; and
changing the security setting corresponding to the incident of the information processing device to security setting corresponding to the setting level determined at the determining.
